(19) United States
(12) Patent Application Publication
(10) Pub. No.: US 2014/0092807 A1
(43) Pub. Date: Apr. 3, 2014

(54) REDUCING SYNCHRONIZATION TIMES DURING TESTING OF WIRELESS DEVICES

(71) Applicant: APPLE INC., Cupertino, CA (US)

(72) Inventor: Xuefeng Zhao, Santa Clara, CA (US)

(73) Assignee: APPLE INC., Cupertino, CA (US)

(21) Appl. No.: 13/632,891

(22) Filed: Oct. 1, 2012

Related U.S. Application Data
(60) Provisional application No. 61/707,562, filed on Sep. 28, 2012.

(51) Int. Cl. H04W 56/00; H04W 24/00

(52) U.S. Cl. 370/328

(57) ABSTRACT

The disclosed embodiments provide a system that tests wireless devices. The system includes a signal generator that generates a downlink signal. The system also includes a management apparatus that tests a first wireless device using the downlink signal. During testing of the downlink signal, the management apparatus configures a second wireless device to listen to the downlink signal and save a set of tuning circuit states for synchronizing to the downlink signal. The management apparatus may then configure the second wireless device to load the saved tuning circuit states to expedite synchronization with the downlink signal during subsequent testing of the second wireless device.

### RELATED APPLICATION

This application hereby claims priority under 35 U.S.C. §119 to U.S. Provisional Application No. 61/707,562, entitled “Reducing Synchronization Times During Testing of Wireless Devices,” by Xuefeng Zhao, filed 28 Sep. 2012 (Atty. Docket No.: APL-P17306USP1).

### BACKGROUND

1. Field

The disclosed embodiments relate to techniques for testing wireless devices. More specifically, the disclosed embodiments relate to techniques for reducing synchronization times between the wireless devices and downlink signals during testing of the wireless devices.

2. Related Art

Recent improvements in computing power and wireless networking technology have significantly increased the capabilities of portable electronic devices. For example, laptop computers, tablet computers, portable media players, smartphones, and/or other modern computing devices are typically equipped with wireless and/or cellular networking capabilities that allow the computing devices to retrieve webpages, stream audio and/or video, share desktops and/or user interfaces (UIs), and/or transfer files wirelessly among one another.

Before a wireless device is purchased and/or used by a user, the wireless device may be tested at a factory to verify the operability of the wireless device. For example, a mobile phone may be tested by placing the mobile phone into an RF shielded enclosure and transmitting a downlink signal to the mobile phone. During the test, the downlink signal may transition between multiple frequencies, bands, and/or channels for multiple cellular technologies with which the mobile phone is designed to be compatible to ensure that the mobile phone is operable with the frequencies, bands, channels, and/or cellular technologies. In addition, the mobile phone's ability to decode and/or synchronize with the downlink signal may be analyzed and/or verified by obtaining an uplink signal from the mobile phone confirming decoding of and/or synchronization with the downlink signal for a given frequency, band, channel, and/or technology. On the other hand, if the mobile phone does not synchronize with the downlink signal within a pre-specified period (e.g., 30 seconds), the mobile phone may fail the test.

Moreover, a significant portion of testing time for a wireless device may be taken up by synchronization of the wireless device to the downlink signal. For example, a mobile phone under test may tune phase-locked loops (PLLs), digital tap filters, and/or other tuning circuits associated with the radio receiver of the mobile phone to synchronize to a downlink signal for a new cellular technology. Because the mobile phone has no knowledge of the first channel of the cellular technology occupied by the downlink signal, the mobile phone may be required to repeatedly “guess” the channel until the tuning circuits are tuned to the channel. Such guessing may be repeated for the first channel of each new cellular technology with which the mobile phone is being tested, resulting in a tuning and/or synchronization time of around 10% of the overall test time for the mobile phone.

Hence, what is needed is a mechanism for reducing synchronization times between wireless devices and downlink signals during testing of the wireless devices.

### SUMMARY

The disclosed embodiments provide a system that tests wireless devices. The system includes a signal generator that generates a downlink signal. The system also includes a management apparatus that tests a first wireless device using the downlink signal. During testing of the downlink signal, the management apparatus configures a second wireless device to listen to the downlink signal and save a set of tuning circuit states for synchronizing to the downlink signal. The management apparatus may then configure the second wireless device to load the saved tuning circuit states to expedite synchronization with the downlink signal during subsequent testing of the second wireless device.

### BRIEF DESCRIPTION OF THE FIGURES

FIG. 1 shows a schematic of a system in accordance with the disclosed embodiments.

FIG. 2 shows a flowchart illustrating the process of facilitating wireless testing in accordance with the disclosed embodiments.

FIG. 3 shows a flowchart illustrating the process of testing wireless devices in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present embodiments are not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

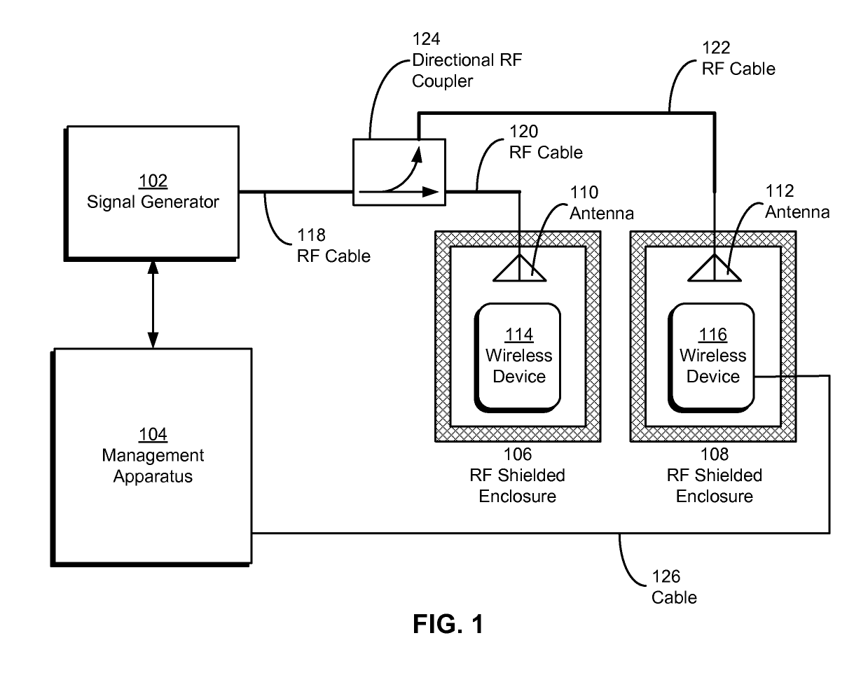

The disclosed embodiments provide a method and system for testing wireless devices such as mobile phones, tablet computers, radio receivers, radio transmitters, and/or other devices with functionality to communicate wirelessly. As shown in FIG. 1, the system may include a signal generator 102 that generates a downlink signal, as well as one or more RF cables 118-120 and an antenna 110 that transmit the downlink signal to a wireless device 114 within a radio-frequency (RF) shielded enclosure 106.

During testing of wireless device 114, a management apparatus 104 (e.g., a computer system) may vary the downlink signal generated by signal generator 102 to verify the ability of wireless device 114 to operate across a number of bands, channels, and/or technologies supported by wireless device 114. For example, management apparatus 104 may transition the downlink signal between channels of multiple cellular technologies supported by wireless device 114, such as the Global System for Mobile Communications (GSM), Code Division Multiple Access (CDMA), Universal Mobile Telecommunications Systems (UMTS), and/or Long Term Evolution (LTE) cellular technologies.

In addition, management apparatus 104 may confirm that wireless device 114 has synchronized with each channel before transitioning the downlink signal to a new channel and/or technology. For example, a signal analyzer associated with management apparatus 104 and/or signal generator 102 may analyze an uplink signal from wireless device 114 to determine if wireless device 114 has synchronized with the downlink signal. Alternatively, management apparatus 104 may monitor a log buffer on wireless device 114 for an entry indicating successful synchronization with the downlink signal. If wireless device 114 synchronizes with the downlink signal within a pre-specified period (e.g., 30 seconds), management apparatus 104 may transition the downlink signal to the next channel and/or technology in the test. If wireless device 114 does not synchronize with the downlink signal within the pre-specified period, management apparatus 104 may determine that wireless device 114 has failed the test.

Those skilled in the art will appreciate that synchronization with the downlink signal may require tuning of phase-locked loops (PLLs), digital filter taps, and/or other tuning circuits in wireless device 114. In addition, wireless device 114 may lack knowledge of the channels occupied by the downlink signal during the test. As a result, wireless device 114 may be required to “guess” the first channel of each new technology (e.g., cellular technology) occupied by the downlink signal by adjusting the tuning circuits until wireless device 114 arrives at the channel. In turn, the lack of channel and/or tuning information for the tuning circuits may cause wireless device 114 to spend a significant portion of the total test time (e.g., 10%) adjusting the tuning circuits to synchronize with the downlink signal.

In one or more embodiments, the system of FIG. 1 includes functionality to expedite synchronization with the downlink signal during wireless device testing by directing the downlink signal to a second wireless device 116 in a separate RF shielded enclosure 108 during testing of wireless device 114. For example, a directional RF coupler 124 may be used to couple an RF cable 122 and antenna 112 to the downlink signal transmitted over RF cable 118, thus exposing wireless device 116 to the downlink signal within RF shielded enclosure 108. Directional RF coupler 124 may also attenuate a signal reflected back along RF cable 122 to prevent the reflected signal from interfering with the testing of wireless device 114.

Management apparatus 104 may additionally configure wireless device 116 to listen to the downlink signal and save a set of tuning circuit states for synchronizing to the downlink signal while wireless device 114 is being tested. For example, management apparatus 104 may place wireless device 116 in a receive mode by transmitting a command for the receive mode over a cable 126 (e.g., a Universal Serial Bus (USB) cable) connected to wireless device 116. While in the receive mode, wireless device 116 may tune PLLs, digital filter taps, and/or other tuning circuits to decode and/or synchronize with the downlink signal. After wireless device 116 has synchronized with the downlink signal using a particular technology (e.g., cellular technology), wireless device 116 may save a tuning circuit state of the tuning circuits in memory on wireless device 116. Wireless device 116 may then save another tuning circuit state of the tuning circuits after wireless device 116 has synchronized with the downlink signal using a different technology. In other words, wireless device 116 may save multiple tuning circuit states for multiple technologies with which wireless device 116 is compatible while wireless device 116 listens to the downlink signal.

After testing of wireless device 114 is complete, wireless device 116 may be moved to RF shielded enclosure 106, and a new wireless device may be placed in RF shielded enclosure 108. The process may then repeat, with testing of wireless device 116 within RF shielded enclosure 106 using the same downlink signal and the direction of the downlink signal to the new wireless device within RF shielded enclosure 108.

During testing of wireless device 116, management apparatus 104 and/or a test program on wireless device 116 may configure wireless device 116 to load the saved tuning circuit states to expedite synchronization with the downlink signal. For example, wireless device 116 may load a saved tuning state for a cellular technology from memory after management apparatus 104 transitions the downlink signal to the first channel of the cellular technology. The tuning state may give wireless device 116 a “known starting point” for synchronizing with the downlink signal, resulting in a reduction in the amount of time required to synchronize with the downlink signal. Moreover, the configuration of the new wireless device using the downlink signal during testing of wireless device 116 may also reduce the synchronization time of the new wireless device with the downlink signal during subsequent testing of the new wireless device.

Consequently, the system of FIG. 1 may conduct wireless device testing using a sequence of pairs of wireless devices; each pair may include a first wireless device under test in RF shielded enclosure 106 and a second wireless device listening to the downlink signal in RF shielded enclosure 108. The next pair in the sequence may include the second wireless device under test in RF shielded enclosure 106 and a third wireless device listening to the downlink signal in RF shielded enclosure 108. By exposing each wireless device to the downlink signal during testing of a different wireless device using the downlink signal, the system of FIG. 1 may reduce the synchronization time between the wireless device and the downlink signal during subsequent testing of the wireless device. In turn, the reduced synchronization times may reduce the overall testing times of the wireless devices, thus facilitating efficient testing of the wireless devices.

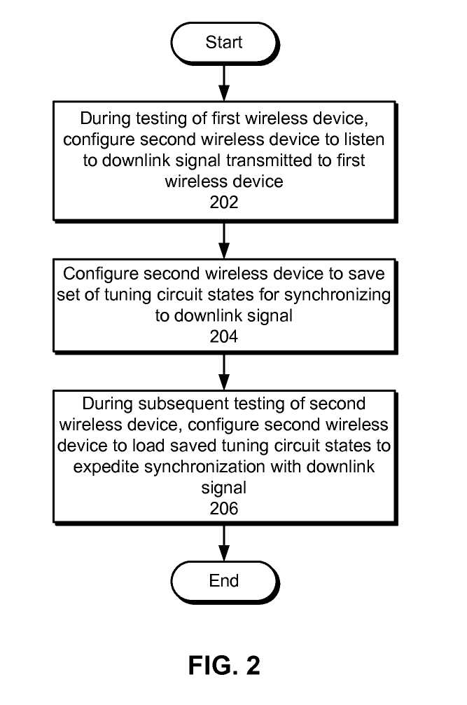

FIG. 2 shows a flowchart illustrating the process of facilitating wireless testing in accordance with the disclosed embodiments. In one or more embodiments, one or more of the steps may be omitted, repeated, and/or performed in a different order. Accordingly, the specific arrangement of steps shown in FIG. 2 should not be construed as limiting the scope of the embodiments.

Initially, a second wireless device is configured to listen to a downlink signal transmitted to a first wireless device during testing of the first wireless device (operation 202). For example, the second wireless device may be placed into a receive mode within an RF shielded enclosure, and the downlink signal may be directed to the second wireless device using a directional RF coupler. The first and second wireless devices may be mobile phones, tablet computers, radio receivers, radio transmitters, and/or other devices with functionality to communicate wirelessly.

The second wireless device is also configured to save a set of tuning circuit states for synchronizing to the downlink signal (operation 204) during testing of the first wireless device. For example, the second wireless device may be notified of a transition to a particular cellular technology by the downlink signal. The second wireless device may then adjust parameters for a set of tuning circuits (e.g., PLLs, digital filter taps, etc.) during transmission of the downlink signal in the cellular technology and save the parameters in memory on the second wireless device.

Finally, the second wireless device is configured to load the saved tuning circuit states to expedite synchronization with the downlink signal during subsequent testing of the second wireless device (operation 206). For example, the second wireless device may load a previously saved tuning circuit state for a cellular technology during transmission of the downlink signal using a first channel for the cellular technology. The second wireless device may then load a different saved tuning circuit state for another cellular technology after the downlink signal transitions to the other cellular technology. Because the saved tuning circuit state enables synchronization to the downlink signal from a “known starting point,” the second wireless device may synchronize to the downlink signal more quickly than a wireless device that lacks saved tuning circuit states for the cellular technologies.

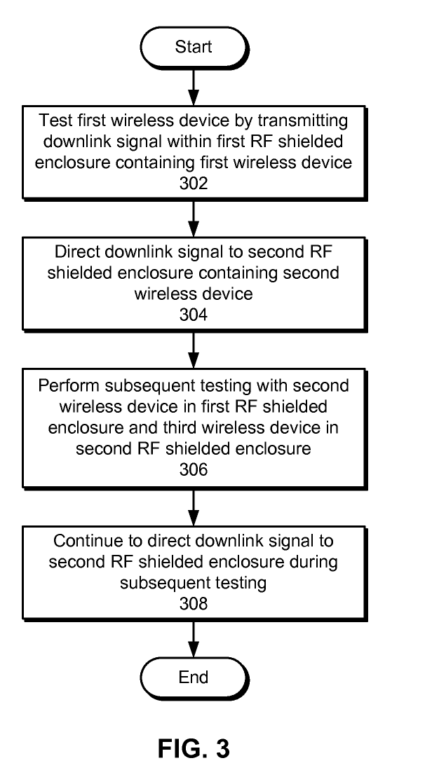

FIG. 3 shows a flowchart illustrating the process of testing wireless devices in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

First, a first wireless device is tested by transmitting a downlink signal within a first RF shielded enclosure containing the first wireless device (operation 302). For example, the downlink signal may be transmitted to the first RF shielded enclosure using one or more RF cables. The downlink signal is also directed to a second RF shielded enclosure containing a second wireless device (operation 304). For example, a directional RF coupler may be used to direct the downlink signal to the second RF shielded enclosure and attenuate any signal that may be reflected back toward a signal generator and/or signal analyzer associated with the downlink signal. The downlink signal may then be used by the second wireless device to save a set of tuning circuit states for synchronization with the downlink signal during subsequent testing of the second wireless device.

The subsequent testing is then performed with the second wireless device in the first RF shielded enclosure and a third wireless device in the second RF shielded enclosure (operation 306). During the subsequent testing, the downlink signal continues to be directed to the second RF shielded enclosure during the subsequent testing (operation 308). The second wireless device may expedite synchronization with the downlink signal by loading the saved tuning circuit state for a technology (e.g., cellular technology) during transmission of the downlink signal using a first channel from the technology. At the same time, the third wireless device may configure and save a corresponding tuning circuit state for the technology to facilitate synchronization with the downlink signal during subsequent testing of the third wireless device.

Such wireless device testing using pairs of wireless devices may allow one wireless device to be “prepared” for testing while the other wireless device is tested. Consequently, the synchronization time for each wireless device may be reduced during the test without incurring additional overhead outside of the time spent testing the wireless devices, resulting in a decrease in the overall time occupied by activities associated with testing the wireless devices.

The foregoing descriptions of various embodiments have been presented only for purposes of illustration and description. They are not intended to be exhaustive or to limit the present embodiments to the forms disclosed. Accordingly, many modifications and variations will be apparent to practitioners skilled in the art. Additionally, the above disclosure is not intended to limit the present embodiments.

What is claimed is:

1. A method for facilitating wireless testing, comprising:
during testing of a first wireless device, configuring a second wireless device to:
listen to a downlink signal transmitted to the first wireless device; and
save a set of tuning circuit states for synchronizing to the downlink signal; and
during subsequent testing of the second wireless device, configuring the second wireless device to load the saved tuning circuit states to expedite synchronization with the downlink signal.

2. The method of claim 1, wherein configuring the second wireless device to listen to the downlink signal involves:
placing the second wireless device in a receive mode.

3. The method of claim 1, wherein the second wireless device listens to the downlink signal within a radio-frequency (RF) shielded enclosure.

4. The method of claim 1, wherein the downlink signal is associated with a set of cellular technologies.

5. The method of claim 4, wherein each of the cellular technologies is associated with a set of channels.

6. The method of claim 5, wherein configuring the second wireless device to load the saved tuning circuit states involves:
configuring the second wireless device to load a saved tuning circuit state for a cellular technology from the set of cellular technologies during transmission of the downlink signal using a first channel from the set of channels for the cellular technology.

7. The method of claim 1, wherein the tuning circuit states are associated with at least one of a phase-locked loop (PLL) and a digital filter tap.

8. A method for testing wireless devices, comprising:
testing a first wireless device by transmitting a downlink signal within a first radio-frequency (RF) shielded enclosure containing the first wireless device; and
directing the downlink signal to a second RF shielded enclosure containing a second wireless device, wherein the downlink signal is used by the second wireless device to save a set of tuning circuit states for synchronization with the downlink signal during subsequent testing of the second wireless device.

9. The method of claim 8, further comprising:
performing the subsequent testing with the second wireless device in the first RF shielded enclosure and a third wireless device in the second RF shielded enclosure; and
continuing to direct the downlink signal to the second RF shielded enclosure during the subsequent testing.

10. The method of claim 8, wherein testing the first wireless device further involves at least one of:
detecting synchronization of the first wireless device with the downlink signal; and
analyzing an uplink signal from the first wireless device.

11. The method of claim 8, wherein the downlink signal is directed to the second RF shielded enclosure using a directional RF coupler.

12. The method of claim 8, wherein the downlink signal is associated with a set of cellular technologies.

13. The method of claim 12, wherein each of the cellular technologies is associated with a set of channels.

14. The method of claim 8, wherein the tuning circuit states are associated with at least one of a phase-locked loop (PLL) and a digital filter tap.

15. A system for testing wireless devices, comprising:
a signal generator configured to generate a downlink signal; and
a management apparatus configured to:
test a first wireless device using the downlink signal; and
configure a second wireless device to:
listen to the downlink signal during testing of the first wireless device; and
save a set of tuning circuit states for synchronizing to the downlink signal.

16. The system of claim 15, further comprising:
a first radio-frequency (RF) shielded enclosure containing the first wireless device; and
a second RF shielded enclosure containing the second wireless device.

17. The system of claim 16, further comprising:
one or more RF cables configured to transmit the downlink signal to the first RF shielded enclosure; and
a directional RF coupler configured to direct the downlink signal to the second RF shielded enclosure.

18. The system of claim 15, wherein the management apparatus is further configured to:
configure the second wireless device to load the saved tuning circuit states to expedite synchronization with the downlink signal during subsequent testing of the second wireless device.

19. The system of claim 18, wherein the downlink signal is associated with a set of cellular technologies.

20. The system of claim 19, wherein each of the cellular technologies is associated with a set of channels.

21. The system of claim 20, wherein configuring the second wireless device to load the saved tuning circuit states involves:
configuring the second wireless device to load a saved tuning circuit state for a cellular technology from the set of cellular technologies during transmission of the downlink signal using a first channel from the set of channels for the cellular technology.

22. The system of claim 15, wherein testing the first wireless device involves at least one of:
detecting synchronization of the first wireless device with the downlink signal; and
analyzing an uplink signal from the first wireless device.

23. The system of claim 15, wherein the tuning circuit states are associated with at least one of a phase-locked loop (PLL) and a digital filter tap.
